(19) United States
(12) Patent Application Publication
(10) Pub. No.: US 2021/0095398 A1
(43) Pub. Date: Apr. 1, 2021

(54) NANOFIBERS FROM SUBSTITUTED POLYANILINE AND METHODS OF SYNTHESIZING AND USING THE SAME

(71) Applicant: The Regents of the University of California, Oakland, CA (US)

(72) Inventors: Henry Hiep D. Tran, Fountain Valley, CA (US); Richard B. Kaner, Los Angeles, CA (US)

(21) Appl. No.: 16/872,834

(22) Filed: May 12, 2020

Related U.S. Application Data
(63) Continuation of application No. 14/928,207, filed on Oct. 30, 2015, now abandoned.
Application No. 14/928,207 is a division of application No. 13/181,241, filed on Jul. 12, 2011, now abandoned.
Application No. 13/181,241 is a continuation-in-part of application No. 11/882,408, filed on Aug. 1, 2007, now abandoned.
(60) Provisional application No. 60/834,489, filed on Aug. 1, 2006.

(51) Int. Cl. D01F 6/96; D01D 5/38; B82Y 30/00; D01F 6/76; H01B 1/12

(52) U.S. Cl. CPC D01F 6/96; D01D 5/38; Y10T 428/298; D01F 6/76; H01B 1/128; B82Y 30/00

(57) ABSTRACT

Embodiments of this invention are directed to substituted polyaniline nanofibers and methods of synthesizing and using the same. The invention is also directed to polyaniline derivatives that can be synthesized without the need for templates or functional dopants by using an initiator as part of a reaction mixture.

### CROSS REFERENCE TO RELATED APPLICATIONS

This application is a continuation-in-part of U.S. patent application Ser. No. 11/882,408, filed Aug. 1, 2007, which claims priority to U.S. Provisional Application No. 60/834,489, filed Aug. 1, 2006. The contents of both applications are incorporated herein in their entirety.

This invention was made with Government support of Grant No. DMR 0507294, awarded by the National Science Foundation, NSF-NIRT program.

### FIELD

Embodiments of this invention are directed to nanofiber materials prepared from aniline derivatives and methods of synthesizing and using the same. In some embodiments, the invention is directed to nanofiber materials synthesized from aniline derivatives, and methods of making the same, without the need for templates or functional dopants by using an initiator as part of a reaction mixture.

### BACKGROUND

Since their discovery, conducting polymers have shown great promise in a variety of applications such as light emitting diodes, chemical sensors, anti-corrosion coatings, batteries, and capacitors. See MacDiarmid, A. G., Angew. Chem., Int. Ed. 2001, 40, 2581-2590. Among the family of conducting polymers, polyaniline has been one of the most widely studied due to its stability and reversible acid/base doping/dedoping chemistry. In recent years, one-dimensional (1-D) nanostructures of polyaniline have attracted growing attention due to the potential advantages of having an organic conductor with low-dimensions. Such materials are potentially useful for applications that depend on ultra-small, low-dimensional structures such as chemical sensors. See Virji, S.; Huang, J.; Kaner, R. B.; Weiller, B. H. Nano Lett., 2004, 4, 491-496.

A variety of chemical methods have been employed to synthesize 1-D nanostructures of polyaniline such as rods, wires, tubes, and fibers. Examples include: (1) template directed synthesis (see Wu, C. G.; Bein, T. Science 1994, 264, 1757-1759); (2) the addition of surfactants (see Michaelson, J. C.; McEvoy, A. J. Chem. Commun. 1994, 1, 79-80), (3) micelles (see Yang, Y. S.; Wan, M. X.; J. Mater. Chem. 2002, 18, 917-921) or seeds (Zhang, X.; Goux, W. J.; Manohar, S. K. J. Am. Chem. Soc. 2004, 126, 4502-4503); (4) interfacial polymerization (see, e.g., Huang, J.; Virji, S.; Weiller, B. H.; Kaner, R. B. J. Am. Chem. Soc. 2003, 125, 314-315; Huang, J.; Kaner, R. B. J. Am. Chem. Soc. 2004, 126, 851-855) and (5) rapidly mixed polymerization (see Huang, J.; Kaner, R. B. Angew. Chem., Int. Ed. 2004, 43, 5817-5821).

However, despite the variety of synthetic methods reported, nanostructures of polyaniline derivatives have been synthesized with only limited success. Compared to the parent polymer, polyaniline derivatives can exhibit enhanced properties such as: (1) improved dispersability in organic solvents such as methanol (see Gruger, A.; Novak, A.; Regis, A.; Colomban, J. Mol. Struct., 1994, 328, 153-167; Yang, S. M.; Chiang, J. H.; Synth. Met., 1991, 41, 761-764); (2) higher resistance against microbial and chemical degradation (see Kwon, A. H.; Conklin, J. A.; Makhinson, M.; Kaner, R. B. Synth. Met., 1997, 84, 95-96; Cihaner, A.; Onal, A. M. Eur. Polym. J., 2001, 37, 1767-1772) and (3) be an attractive alternative to charge dissipaters for e-beam lithography (see Angelopoulos M., Shaw J. M., Kaplan R. D., and Perreault S., J. Vac. Sci. Technol., 1989, B 7, 6, 1519). Thus, there is a need in the art for improved processes capable of synthesizing polyaniline derivatives.

### SUMMARY

Embodiments of the present invention are directed to methods of producing nanofibers comprising: forming a mixture comprising an aniline derivative monomer, an oxidant, and an initiator; and reacting the mixture to form a nanofiber. Some embodiments are directed to the nanofibers produced by these methods.

### DESCRIPTION OF THE DRAWINGS

FIG. 1 Shows the UV-Vis spectra of dedoped (dashed line, - - - ) and doped (solid line, -) polyanisidine in water.

FIG. 2 Shows scanning electron microscope (SEM) images demonstrating the change in the morphology of poly-2-ethylaniline (A,B), poly-o-toluidine (C,D), and poly-o-anisidine (E,F) when synthesized with (right column) or without (left column) an initiator.

FIG. 3 Shows a SEM image of poly-o-toluidine polymerized while being vigorously shaken in the presence of an initiator.

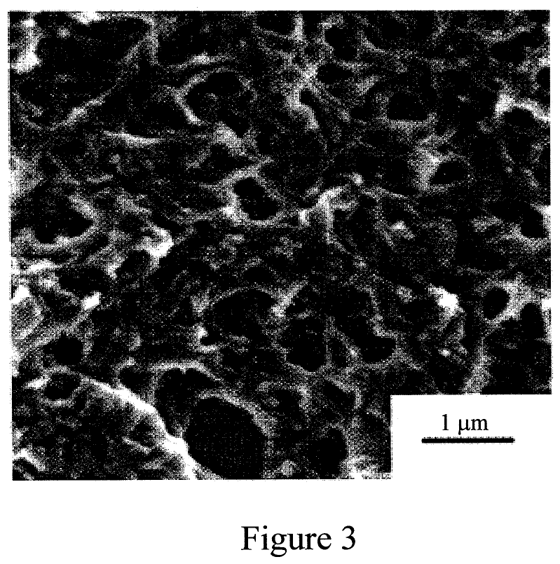

FIG. 4 Shows the UV-Vis spectra of dedoped polytoluidine (dot-dashed line, - ⋅ - ⋅ -), polyanisidine (solid line, -), and polyethylaniline (dashed line, - - - ) in N-methyl-2-pyrrolidine.

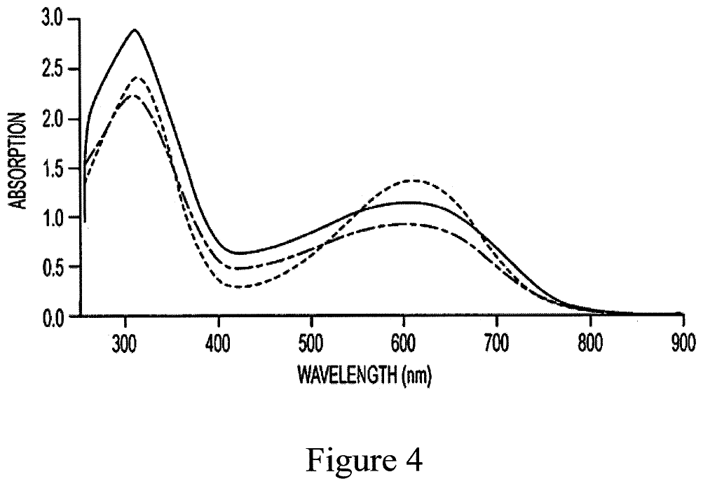

FIG. 5 Shows SEM images of polymers according to the invention and comparative polymers prepared from aniline derivatives. FIG. 5A shows poly-2-ethylaniline synthesized by the procedure described in comparative example 1. FIG. 5B shows poly-2-ethylaniline synthesized by the procedure described in Example 2. FIG. 5C shows poly-o-toluidine synthesized by the procedure described comparative example 1. FIG. 5D shows Poly-o-toluidine synthesized by the procedure described in Example 2. FIG. 5E shows Poly-o-ansidine synthesized by the procedure described in comparative example 1. FIG. 5F shows Poly-o-ansidine synthesized by the procedure described in Example 2.

FIG. 6 Shows an SEM image of poly-2-ethylaniline synthesized with p-phenylenediamine as an additive at dilute concentrations.

### DETAILED DESCRIPTION

Embodiments of the present invention are directed to an improved scalable procedure for producing nanofibrous mats out of a wide variety of polyaniline derivatives by introducing an initiator into the reaction mixture of a rapidly mixed reaction between a solution of an aniline derivative monomer and oxidant. It has been discovered that nanofibers appear to be the intrinsic morphology of polyaniline and that structural directing agents such as templates and surfactants are not required for nanofiber formation. See Huang, J.; Kaner, R. B. Chem. Comm. 2006, 367-376. By not stirring the reaction mixture after the synthesis has begun, it has also been discovered that high-quality nanofibrous mats can be produced regardless of whether or not the monomer and oxidant solutions are added slowly or rapidly. See Li, D.; Kaner, R. B. J. Am. Chem. Soc. 2006, 128, 968-975.

Embodiments of the present invention are also directed to a novel chemical route that can be used to synthesize nanofibrous mats of a wide variety of polyaniline derivatives. Polyaniline derivatives, as used herein, refers to poymers prepared from one or more aniline molecule(s) having one or more substituent, not aniline itself. Suitable substituents include alkyl (i.e. C₁ to C₆ alkyl, such as methyl, ethyl, propyl, ispropyl, etc.), alkoxy (i.e. —O-alkyl, e.g., C₁ to C₆ alkoxy such as, methoxy, ethoxy, etc.), carboxyl (—COOX where X is a hydrogen or cationic counterion), alkyl-carboxyl (-alkyl-COOX, e.g., alkyl groups of C₁ to C₆ substituted by COOX, where X is a hydrogen or cationic counterion), halogen (i.e. fluoro, chloro, bromo, iodo), thiol (—SH), thioalkyl (i.e. —S-alkyl, e.g., C₁ to C₆ thioalkyl such as thiomethyl, thioethyl, etc.), sulfonic acid or sulfonate salt thereof (i.e. —SO₃X, where X is a hydrogen or cationic counterion), alkyl sulfonates (i.e. —SO₃R, where R is a C₁-C₆ alkyl). The substituent may be, for example, at the 2- or 3-position (or equivalent 5- or 6-position) of the aniline derivative. The “aniline derivative” may have more than one substituent, up to 4 total substituents (in addition to the aniline —NH₂), such that the aniline derivative has at least one available aromatic hydrogen for polymerization. The substituents may be the same or different. Accordingly, the aniline derivative may be, for example, a dialkylaniline, alkyl-alkoxy aniline, dihaloaniline, dialkoxyaniline, etc. In embodiments with multiple substituents, the aniline may be, for example, 2,6-substituted, 2,5-substituted, 2,3-substituted, 2,3,6-substituted, 2,3,5-substituted, or 2,3,5,6-substituted.

As described above, nanofibers have been prepared from substiuted anilines with only limited success. In general, nanofibers of polymeric aniline derivatives form under special reaction conditions, generally designed to slow the reaction rate. For example, interfacial (e.g. biphasic) polymerization techniques have been used or the polymerization reaction is conducted at low concentrations. According to the present invention, it has been surprisingly found that the addition of initiators (or polymerization inducers) produces nanofibers without the need for special reaction conditions. While not wishing to be bound to a single theory, it is believed that the initiator accelerates the rate of the reactions and may promote homogeneous nucleation, which leads to a nanofibrous morphology. In any event, when used according to the present invention, the initiator is not acting simply to speed the polymerization rate, but unexpectedly has an effect on polymer morphology. As shown in the Examples, simply speeding up the reaction rate, for example, by increasing the concentration of the reactants, does not necessarily lead to nanofiber formation.

Embodiments of the present invention are directed to a method of producing nanofibers, the method comprising: (1) forming a mixture comprising an aniline derivative monomer, an oxidant, and an initiator; and (2) reacting the mixture to form a nanofiber. The method of some embodiments of the present invention can further comprise using mixtures of aniline derivative monomers. In some embodiments, the monomer is an aniline derivative or anisidine.

The term “nanofiber” as used herein is intended to cover any structure having diameters up to 150 nm and lengths as long as three microns. In some embodiments, the nanofiber is electrically conductive.

Suitable aniline derivatives for use as monomers in the present invention include, but are not limited to, alkylanilines, alkoxyanilines, haloanilines (including flouro-, chloro- bromo- and iodo-anilines), alkoxyanilines (including anisidines), carboxyanilines (including anthranillic acid and benzoic acid), thioalkylanilines (such as aminothiophenol and thiomethylaniline), aniline sulfonate, (i.e. —SO₃X substituted aniline, where X is a hydrogen or cationic counterion), aniline with multiple side groups (such as 2-methoxyaniline-5-sulfonic acid) and mixtures thereof. Any substituted aniline, as defined above, may be used.

In some embodiments, the aniline derivative is selected from the group consisting of toluidene, ethylaniline, fluoroaniline, anthranillic acid, benzoic acid, 2-aminothiophenol, chloroaniline, iodoaniline, anisidine, aniline sulfonate, and mixtures thereof.

As used herein, polyaniline derivatives are polymers formed from one or more aniline derivatives. Embodiments of the present invention also include forming a reaction mixture comprising multiple monomers. The reaction mixture can comprise more than one monomer, more than two monomers, or more than three monomers. In some embodiments, the reaction mixture comprises two monomers. In some embodiments, the resulting polymer, i.e. the nanofiber, produced by the synthetic methods disclosed herein can be a copolymer. The copolymer nanofibers produced according to the present invention can comprise the different monomers in any arrangement, for example, the nanofibers can be statistical copolymers, alternating copolymers, block copolymers, or graft copolymers.

As one of skill in the art will appreciate, the selection and ordering of the monomers within a copolymer can be used to control the copolymer's properties and uses. For example, polyaniline derivatives according to the invention can be polymers or copolymers capable of conducting electricity. Exemplary polymers or copolymers can function as a biopolymer that could be used to repair neurons, muscle cells, or any other cellular tissue that conducts electricity within an organism. In some embodiments, these biopolymers could be useful in repairing mammalian tissue, for example, human tissue.

In addition to the monomer, in some embodiments, the reaction mixture of the present invention also includes an oxidant. Any oxidant commonly used to polymeric aniline may be used. The oxidant used in the present invention can be, but is not limited to, ammonium peroxydisulfate, ferric chloride (FeCl₃), and potassium peroxydisulfate. In some embodiments, the oxidant is added as a solution. For example, the oxidant can be a solution of ammonium peroxydisulfate (about 50 mg) in 1M acid.

The reaction may be performed at a range of concentrations. The concentration of aniline in the final reaction may be greater than about 10 mM. The concentration may be greater than about 20 mM, greater than about 50 mM, greater than about 70 mM, or greater than about 100 mM. The concentration of aniline in the final reaction may be less than about 1M, less than about 700 mM, less than about 500 mM, less than about 300 mM, or less than about 200 mM. A range of concentrations between any of the above endpoints may be used.

The rate of the synthesis reaction used to produce the nanofibers of the present invention can be controlled by the addition of an initiator to the reaction mixture. As Wei et al. have noted, by adding aromatic additives such as p-phenylenediamine or 1,4-benzenediamine to an electrochemical synthesis of polyaniline, the rate of polymerization can be enhanced. (See Wei, Y.; Sun, Y.; Jang, G. W.; Tang, X. J. Poly. Sci.: Part C: Poly. Let. 1990, 28, 81; Wei, Y.; Jang, G. W.; Chan, C. C.; Hsueh, K. F.; Hariharan, R.; Patel, S. A.; Whitecar, C. K. J. Phys. Chem. 1990, 94, 7716-7721.) The reaction mixture of the present invention includes an initiator. The initiator used in the present invention can be, but is not limited to, a diamine, a dimer, or a higher oligomer such as a tetramer or octamer. Based upon prior methods of preparing polymeric aniline derivatives, it would be expected that adding an accelerator or initiator to the reaction mixture would disfavor the formation of nanofibrous materials and promote the formation of amorphous or agglommerated structures. It has surprisingly been found that this does not occur when the initiator is used according to the present invention.

The introduction of the initiator into the method of synthesizing nanofibers can have various benefits. For example, it has been observed that after introducing an initiator into the reaction scheme of the present invention, the polyaniline derivatives precipitate out of solution in just a few seconds as opposed to minutes or hours without the initiators.

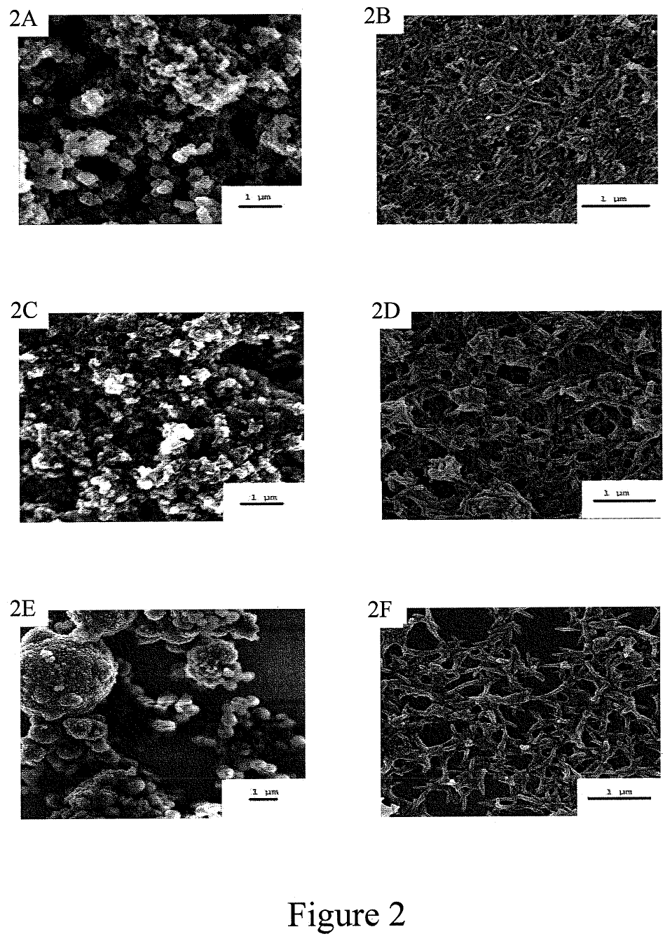

Further, it is believed that the dramatic change in the observed morphology of the nanofibers shown in FIG. 2 can be attributed to the rate enhancement caused by the introduction of the initiator. While not wishing to be bound by any theory, it is believed that the initiators may bias formation of nanofibers by accelerating growth of the nanofiber along the axis of the polymer chain. Furthermore, since the initiators have a much lower oxidation potential than the monomers (see D'Aprano, G.; Lecler, M.; Zotti, G. Synth. Met., 1996, 82, 59-61), they can serve as nucleation sites for the growing polymer chain.

The initiator used in the methods according to the invention can be selected based on the monomers being used to form the nanofiber. For the majority of the polyaniline derivatives synthesized using the present invention, the same nanofibrillar morphology can be obtained using a dimer, a diamine, or any other higher oligomer of aniline, such as a tetramer or octamer as the initiator. Thus, in some embodiments of the present invention the initiator is a dimer, e.g., phenylenediamine; a diamine, e.g., 1,4-benzenediamine; or any other higher oligomer of aniline, such as a tetramer or octamer, or a mixture thereof. However, as one of skill in the art will appreciate, any aromatic amine molecule with a lower oxidation potential than aniline or the aniline derivative and that can be incorporated into the polyaniline chain via a 1,4 linkage could also be used to produce nanofibers of the present invention.

The morphology of the nanofiber can be influenced by the selection of the initiator. For example, the present inventors have found that a nanofibrous mat that is more smooth and continuous is more likely produced when a diamine is used and in other instances when a dimer is used. For instance, when the dimer is used to initiate growth of polyanisidine, more high-quality nanofibrous mats are obtained than when the diamine is used rather than the dimer. However, for the synthesis of polyethylaniline, this effect is reversed.

Once the reaction mixture has been prepared, it is allowed to react to produce the nanofibers of the present invention. In some instances, the reaction rate can dictate whether a nanofiber or an agglomerated structure is formed from the reaction mixture. Thus, the reaction rate can be controlled to produce nanofibrous mats in some embodiments.

For example, while it has been shown that nanofibers appear to be the intrinsic morphology of polyaniline (see Huang, J.; Kaner, R. B. Chem. Comm. 2006, 367-376), the present inventors have observed that nanofibers do not form from polyaniline derivatives under the same synthetic conditions as polyaniline itself. Without wishing to be bound to a single theory, it is believed that this may be due to the slower reaction rate of substituted polyaniline because of both steric and electronic effects. See Mattoso, L. H. C.; Manohar, S. K.; MacDiarmid, A. G.; Epstein, A. J. J. Poly. Sci.: Part A: Poly. Chem. 1995, 33, 1227-1234.

For example, as a case study, o-toluidine was analyzed during the early stages of polymerization and no fibrous structures were observed at any point. Only spherical agglomerates were seen, which suggests that nucleation and growth of polyaniline derivatives is identical in all directions. Therefore, in order to form nanofibers of polyaniline derivatives, anisotropic growth of the nucleation sites must be induced.

It has also been shown that homogeneous nucleation promotes the formation of polyaniline nanofibers. See Li, D.; Kaner, R. B. J. Am. Chem. Soc. 2006, 128, 968-975. In the presence of an initiator, the formation of reactive nuclei is much faster, and as a result it is more likely that they will undergo homogeneous nucleation leading to nanofibers rather than heterogeneous nucleation leading to agglomerated structures. Furthermore, when the reaction mixture with the initiator is vigorously shaken during polymerization an increase in agglomerated structures has been observed, possibly due to an increase in heterogeneous nucleation of the embryonic nuclei.

The dimensions of the nanofibers produced by some embodiments of the present invention can vary depending upon synthetic conditions such as the monomer being polymerized or the acid used during synthesis. For instance, when polymerized in the presence of HCl, m-toluidine gives an average nanofiber diameter of 25 nm, however, in perchloric acid, the average diameter is roughly 75 nm.

In some embodiments, the nanofibers of the present invention can have diameters ranging from about 25 nm to about 120 nm, about 25 nm to about 100 nm, about 25 nm to about 75 nm, or about 25 nm to about 50 nm. The term “about” refers to plus or minus 10% of the indicated number. For example, “about 10 nm” indicates a range of 9 nm to 11 nm.

The nanofibers of the present invention can be as long as several microns. In some embodiments, the nanofibers of the present invention have a length of about 0.5 μm to about 10 μm, about 0.5 μm to about 5 μM, or about 0.5 μm to about 3 μm.

The nanofibers of the present invention can be used in a variety of applications. For example, the enhanced processability parameters, including an exceptionally high dispersability in various solvents, make these nanofibers useful in film applications. For example, the nanofibers of the present invention can be useful in applications requiring high quality films such as chemical sensing or anti-corrosion coatings.

In embodiments of the present invention where a biopolymer is produced, the nanofibers can be used in biomedical applications. For example, biopolymers capable of conducting electricity could be used to repair neurons, muscle cells, or any other cellular tissue that conducts electricity within an organism. In some embodiments, the nanofibers of the present invention are useful in repairing mammalian tissue, for example, human tissue.

The individual nanofibers produced by some embodiments of the present invention can be arranged into nanofibrous mats. For example, into a nanofibrous mat of polyaniline derivatives. Nanofibrous mats of polyaniline derivatives have many useful properties. Preliminary tests on the derivatives indicate that most undergo flash welding when exposed to a camera flash at close proximities, which may be useful in melt-blending polymer-polymer nanocomposites. See Huang, J.; Kaner, R. B. Nat. Mat. 2004, 3, 783-786. Stable aqueous colloids of derivatives such as polyanisidine in its doped state can be prepared in concentrations as high as 2.5 g/L—over 200 times more concentrated than that reported for the parent polymer. See Li, D.; Kaner, R. B. Chem. Commun. 2005, 3286-3288. Furthermore, polyanisidine nanofibers can be easily redispersed into solution after they are dried, which is often difficult to achieve with polyaniline.

The following examples are further illustrative of the present invention, but are not to be construed to limit the scope of the present invention.

### Example 1

In a representative reaction of the present invention, 1-2 milligrams of an initiator (for example, p-phenylenediamine (a dimer) or 1,4 benzenediamine (a diamine)) is predissolved in a minimal amount of methanol. This solution is mixed with a solution of the monomer derivative (about 100-120 milligrams) in 1M acid to form a mixture. This mixture is rapidly mixed with a solution of oxidant, for example, ammonium peroxydisulfate (about 50 mg) in 1M acid.

Upon addition of the oxidant, the characteristic color changes associated with the formation of the polyaniline derivatives are observed within several seconds, an observation consistent with previous studies using oligomers to synthesize chiral polyaniline nanofibers. See Wenguang, L.; Wang, H. L. J. Am. Chem. Soc. 2004, 126, 2278-2279. The reaction mixture is then left unagitated for 1 day, after which time the crude product is collected and purified by dialysis against deionized water.

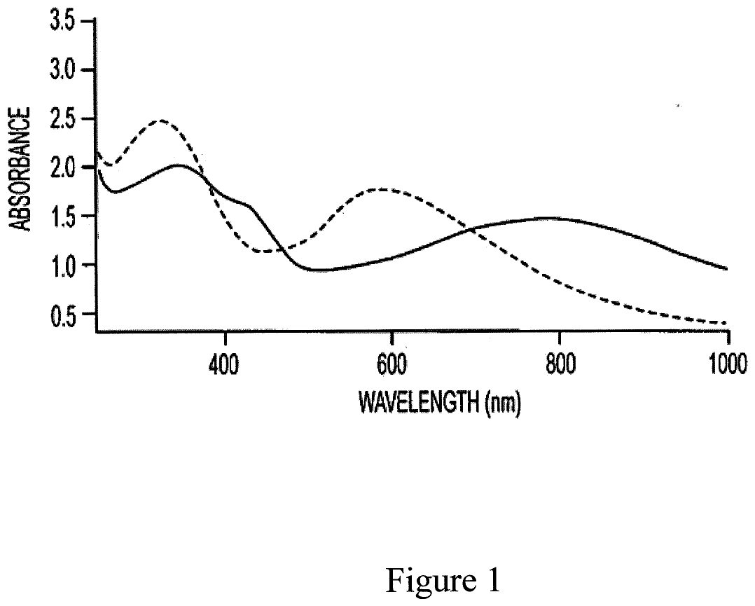

The purified product can be characterized via UV-Vis spectroscopy, which indicates that the polyaniline derivatives exist in the emeraldine oxidation state. For example, FIG. 1 shows the UV-VIS spectrum of a representative polyaniline derivative, polyanisidine in its doped and dedoped state. For each polyaniline derivative synthesized, the ratio of the relative intensity of the 320 run and 610 nm peaks for the dedoped material varies slightly. While not wishing to be bound to a single theory it is believed that this may be due to slight deviations from the ideal half-benzenoid/half-quinoid units characteristic of polyaniline in the emeraldine oxidation state. See Albuquerque, J. E.; Mattoso, L. H. C.; Balogh, D. T.; Faria, R. M.; Masters, J. G.; MacDiarmid, A. G. Synth. Met., 2000, 113, 19-22.

Further, SEM images of polyaniline derivatives reveal a striking contrast between reactions synthesized with an initiator (FIG. 2 B, D, F), according to the procedure in Example 2, and without an initiator (FIG. 2 A, C, E), according to the procedure in Comparative Example 2. For reactions performed in the absence of an initiator, irregularly shaped agglomerates or micron sized spheres are predominantly formed. However, upon introduction of the initiator into the reaction mixture, a dramatic change is seen in the morphology of the product from irregularly shaped agglomerates to nanofibers with lengths as long as several microns and diameters ranging from 25-120 nm, depending upon synthetic conditions such as the monomer being polymerized or the acid used during synthesis. For instance, when polymerized in the presence of HCl, m-toluidine gives an average nanofiber diameter of 25 nm, however, in perchloric acid, the average diameter is roughly 75 nm.

### Example 2

Polymerization of Aniline Derivatives with Added Initiator

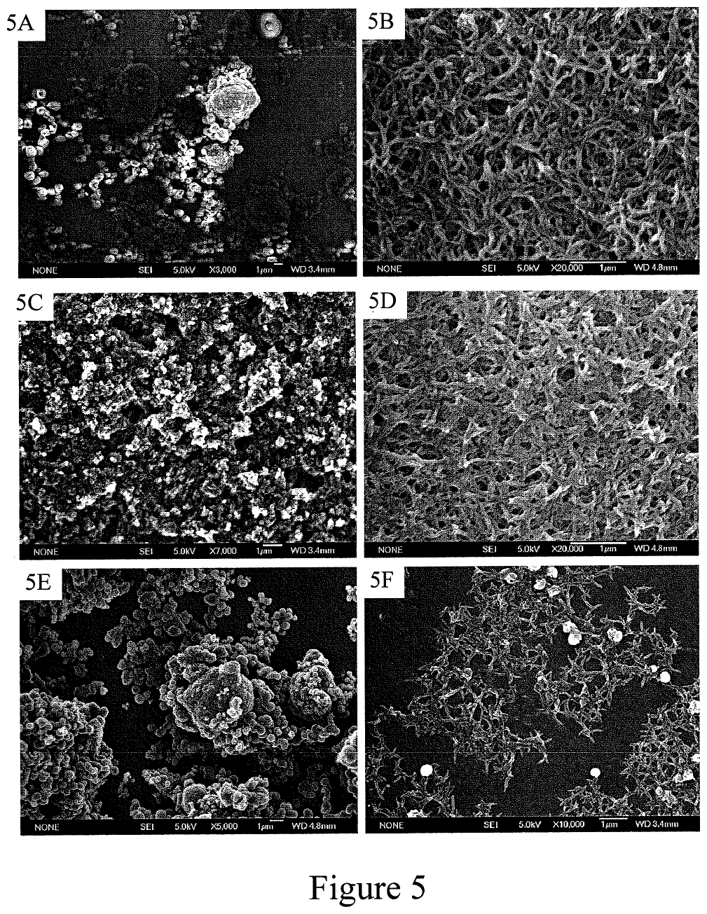

Briefly, p-phenylenediamine (2 mg, 0.19 mmol) was dissolved in a minimal amount of methanol (˜1-2 drops). This solution was added to a solution of 2-ethylaniline (0.12 g, 1 millimole) dissolved in 3 mL of 1M HCl at room temperature. In a separate container, ammonium peroxydisulfate (60 mg, 0.25 millimole, molar ratio of monomer to oxidant is 4:1) was dissolved in 3 mL of 1 M HCl and the two solutions mixed together at room temperature (final concentration of 2-ethylaniline in the reaction was ˜166 mM). The concentration of p-phenylenediamine to 2-ethylaniline is approximately 2%. After a one day reaction time without mixing, the crude product was purified by dialysis (MWCO˜12,000) against deionized water until the pH of the water path is neutral. SEM images of the purified products are shown in FIG. 5B.

Identical processes were carried out for o-toluidine (FIG. 5D) and o-anisidine (FIG. 5F) except the monomer 2-ethylaniline is replaced with either o-toluidine or o-anisidine. The same process was also carried out using p-aniline dimer as an additive rather than p-phenylenediamine and similar results were obtained. The same process was carried out with other aniline derivatives, including 2-fluoro, 3-fluoro, 2-cloro, 3-chloro, 2-iodo, 3-iodo, 2-propyl, 3-propyl, 3-methyl, and 2-sulfonate substituted aniline derivatives, each of which formed nanofibers using this method.

### Example 3

Polymerization of Aniline Derivatives at Low Concentration with Added Initiator

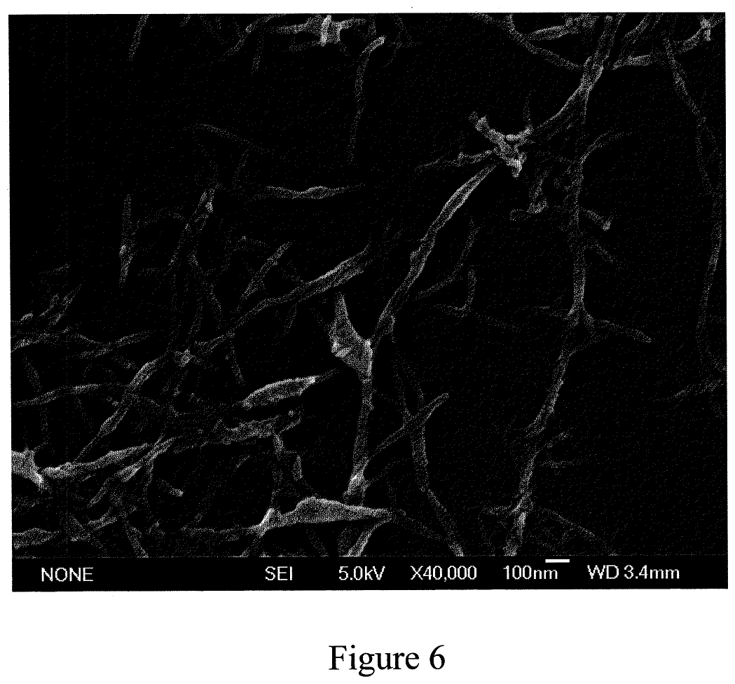

Briefly, p-phenylenediamine (1 mg, 0.1 mmol) was dissolved in a minimal amount of methanol (˜1-2 drops). This solution was added to a solution of 2-ethylaniline (0.1 g, 0.83 millimole) dissolved in 40 mL of 1M HCl at room temperature. In a separate container, ammonium peroxydisulfate (0.1 g, 0.4 millimole, molar ratio of monomer to oxidant is 2:1) was dissolved in 20 mL of 1 M HCl (final concentration of 2-ethylaniline in the reaction was ˜13 mM) and the two solutions mixed together at room temperature. After one day without mixing, the crude product was purified by dialysis (MWCO˜12,000) against deionized water until the pH of the water path was neutral. SEM images of the purified products (FIG. 6) show nanofiber formation.

### Comparative Example 1

### Polymerization of Aniline Derivatives Using Low Concentration

The polymerization of substituted derivatives of aniline was carried out at low concentrations without added initiator, as described by Epstein in US Patent App No 2007/0034836. Many derivatives were polymerized and three are presented here: 2-ethylaniline, o-toluidine, o-anisidine.

Briefly, 2-ethylaniline (0.1 g, 0.83 millimole) was dissolved in 40 mL of 1M HCl at room temperature. In a separate container, ammonium peroxydisulfate (0.1 g, 0.4 millimole, molar ratio of monomer to oxidant is 2:1) was dissolved in 20 mL of 1 M HCl (final concentration of 2-ethylaniline in the reaction was ˜13 mM) and the two solutions mixed together at room temperature. After a one day reaction time without mixing, the crude product was purified by dialysis (MWCO˜12,000) against deionized water until the pH of the water path was neutral. SEM images of the purified products are shown in FIG. 5A.

Identical processes were carried out for o-toluidine (FIG. 5C) and o-anisidine (FIG. 5E) except the monomer 2-ethylaniline is replaced with either o-toluidine or o-anisidine. The same process was also carried out using HClO₄, H₂SO₄, and methanesulfonic acid as an acid for doping and similar results were obtained. In none of these cases were nanofibers formed.

### Comparative Example 2

Briefly, aniline derivatives were synthesized according to Example 2, without added intitator. SEM images (FIG. 2A, C, E) show no nanofiber production.

These examples illustrate possible embodiments of the present invention. As one of skill in the art will appreciate, because of the versatility of the method of producing nanostructures, e.g. nanofibers, the invention disclosed herein can be used to synthesize other nanostructures comprising polymers. Thus, while the invention has been particularly shown and described with reference to some embodiments thereof, it will be understood by those skilled in the art that they have been presented by way of example only, and not limitation, and various changes in form and details can be made therein without departing from the spirit and scope of the invention. Therefore, the breadth and scope of the present invention should not be limited by any of the above-described exemplary embodiments, but should be defined only in accordance with the following claims and their equivalents.

All documents cited herein, including journal articles or abstracts, published or corresponding U.S. or foreign patent applications, issued or foreign patents, or any other documents, are each entirely incorporated by reference herein, including all data, tables, figures, and text presented in the cited documents.

We claim:

1. A method of producing nanofibers comprising: forming a mixture comprising an aniline derivative monomer, an oxidant, and an initiator; and reacting the mixture to form a nanofiber.

2. The method of claim 1, comprising more than one monomer.

3. The method of claim 1, wherein the aniline derivative is selected from the group consisting of alkylanilines, alkoxyanilines, haloanilines, anisidines and mixtures thereof.

4. The method of claim 1, wherein the aniline derivative monomer is selected from the group consisting of toluidene, ethylaniline, fluoroaniline, and mixtures thereof.

5. The method of claim 1, wherein the oxidant is selected from the group consisting of ammonium peroxydisulfate, ferric chloride, potassium peroxydisulfate, and mixtures thereof.

6. The method of claim 5, wherein the oxidant is ammonium peroxydisulfate.

7. The method of claim 1, wherein the initiator is a diamine, a dimer, or an oligomer.

8. The method of claim 7, wherein the initiator is selected from the group consisting of p-phenylenediamine, 1,4-benzenediamine, and mixtures thereof.

9. The method of claim 7, wherein the initiator is p-phenylenediamine or 1,4-benzenediamine.

10. The method of claim 1, wherein the aniline derivative monomer is aniline sulfonate.

11. The method of claim 1, wherein the aniline derivative monomer is a thioaniline.

12. The method of claim 1, wherein the nanofiber is a polyaniline derivative.

13. The method of claim 1, wherein the nanofiber is a polyanisidine.

14. The method of claim 1, wherein the concentration of the aniline derivative monomer in the mixture is greater than about 10 millimolar.

15. A nanofiber produced by forming a mixture comprising an aniline derivative monomer, an oxidant, and an initiator; and reacting the mixture to form a nanofiber.

16. The nanofiber of claim 15, wherein the aniline derivative monomer is selected from the group consisting of alkylanilines, alkoxyanilines, haloanilines, anisidines, aniline sulfonate and mixtures thereof.

17. The nanofiber of claim 15, wherein the aniline derivative monomer is aniline sulfonate.

18. The nanofiber of claim 15, wherein the nanofiber has a length of about 0.5 μm to about 10 μm.

19. The nanofiber of claim 15, wherein the nanofiber has a diameter of about 25 nm to about 120 nm.

20. The nanofiber of claim 15, wherein the nanofiber is electrically conductive.

21. The nanofiber of claim 15, wherein the nanofiber comprises a monomer selected from the group consisting of anisidine, toluidene, ethylaniline, fluoroaniline, and mixtures thereof.
